(19) United States
(12) Patent Application Publication
(10) Pub. No.: US 2022/0147821 A1
(43) Pub. Date: May 12, 2022

(54) COMPUTING DEVICE, COMPUTER SYSTEM, AND COMPUTING METHOD

(71) Applicant: Kioxia Corporation, Tokyo (JP)

(72) Inventors: Kengo Nakata, Kawasaki (JP); Daisuke Miyashita, Kawasaki (JP); Jun Deguchi, Kawasaki (JP)

(73) Assignee: Kioxia Corporation, Tokyo (JP)

(21) Appl. No.: 17/344,192

(22) Filed: Jun. 10, 2021

(30) Foreign Application Priority Data
Nov. 6, 2020 (JP) 2020-186016

(51) Int. Cl. G06N 3/08; G06N 3/04

(52) U.S. Cl. CPC G06N 3/08; G06N 3/04

(57) ABSTRACT

According to one embodiment, a processor is configured to calculate a calculation amount in inference time of a neural network, using a result of summing, with respect to a group to which quantization is applied, products of the number of product-sum operations and bit widths of weight for the product-sum operations in the neural network. Then, the processor is configured to optimize a value of the weight and a quantization step size to minimize the recognition error by the neural network based on the calculated calculation amount, and execute computing about the neural network based on the optimized weight and the quantization step size.

### CROSS-REFERENCE TO RELATED APPLICATIONS

This application is based upon and claims the benefit of priority from Japanese Patent Application No. 2020-186016, filed on Nov. 6, 2020; the entire contents of which are incorporated herein by reference.

### FIELD

Embodiments described herein relate generally to a computing device, a computer system, and a computing method.

### BACKGROUND

Neural networks have been widely used, for example, in computing of image recognition processing. For example, high recognition accuracy can be achieved in a task of image recognition by using a convolutional neural network (CNN), which is one of neural networks. However, in inference using such a convolutional neural network (CNN), reduction of processing time and power consumption is required because millions of product-sum operations are executed.

Conventionally, regularization methods of optimizing the processing time and power consumption taken for inference in consideration of a model size and memory usage of a convolutional neural network (CNN) have been studied.

However, according to the conventional optimization methods, calculation amounts and the calculation performance of hardware were not considered.

### BRIEF DESCRIPTION OF THE DRAWINGS

FIG. 1 is a block diagram illustrating an example of a configuration of a computer system including a computing device of an embodiment;

FIG. 2 is a schematic diagram for explaining a configuration example of a neural network executed by the computer system of the embodiment;

FIG. 3 is a functional block diagram illustrating a functional configuration of the computing device of the embodiment;

FIG. 4 is a flow chart illustrating a flow of an optimization process based on a gradient descent method of the embodiment;

FIG. 5 is a diagram illustrating an example of quantization of the embodiment;

FIG. 6A is a diagram illustrating a measurement example by a method of a comparative example;

FIG. 6B is a diagram illustrating a measurement example by a method of the embodiment;

FIG. 7 is a diagram illustrating differences in effects of the method of the embodiment and the method of the comparative example;

FIG. 8 is a diagram illustrating an example of a relation between a calculation amount (MAC×bit) and a recognition accuracy in the methods of the embodiment and the comparative example;

FIG. 9 is a diagram illustrating an example of differences in effects of bit widths in the methods of the embodiment and the comparative example; and

FIG. 10 is a diagram exemplarily illustrating a cumulative model size after a weight and a quantization step size are adjusted in the methods of the embodiment and the comparative example.

### DETAILED DESCRIPTION

According to one embodiment, a processor is configured to calculate a calculation amount in inference time of a neural network, using a result of summing, with respect to a group to which quantization is applied, products of the number of product-sum operations and bit widths of weight for the product-sum operations in the neural network. Then, the processor is configured to optimize a value of the weight and a quantization step size to minimize a recognition error by the neural network based on the calculated calculation amount, and execute computing about the neural network based on the optimized weight and the quantization step size.

Hereinafter, with reference to accompanying drawings, a computing device, a computer system, and a computing method according to the embodiment will be described in detail. Note that the present invention is not limited by this embodiment.

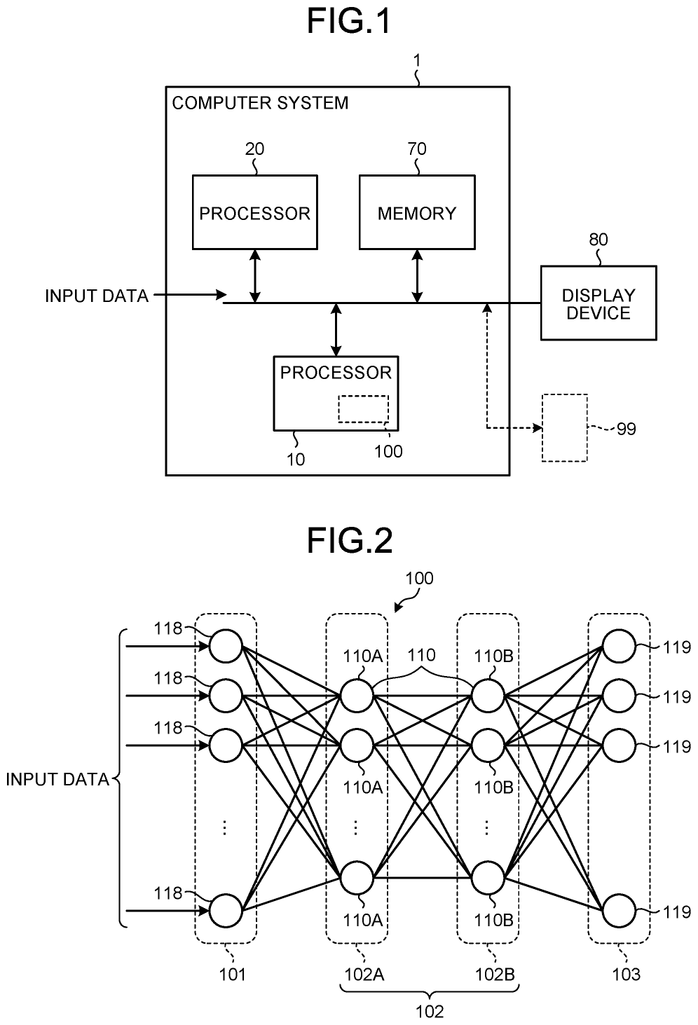

FIG. 1 is a block diagram illustrating an example of a configuration of a computer system 1 including a computing device of the embodiment. As illustrated in FIG. 1, the computer system 1 receives input data. The input data may be, for example, voice data, text data generated from voice data, or image data. The computer system 1 executes various processing with respect to the input data. For example, if the input data is voice data, the computer system 1 executes natural language processing. For example, if the input data is image data, the computer system 1 executes image recognition processing.

The computer system 1 can output signals corresponding to the result of the processing with respect to the input data and cause a display device 80 to display the result of the processing. The display device 80 is, for example, a liquid crystal display or an organic EL display. The display device 80 is electrically connected to the computer system 1 via a cable or wireless communication.

The computer system 1 includes at least a graphic processing unit (GPU) 10, a central processing unit (CPU) 20, and a memory 70. The GPU 10, the CPU 20, and the memory 70 are connected by an internal bus so that communication can be carried out.

In the present embodiment, the GPU 10 executes computing about inference processing using a later-described neural network 100. The GPU 10 is a processor which carries out similarity calculations in an approximative manner. The GPU 10 executes processing with respect to the input data while using the memory 70 as a work area.

The CPU 20 is a processor, which controls the whole operation of the computer system 1. The CPU 20 executes various processing for control of the GPU 10 and the memory 70. The CPU 20 controls computing, which uses the neural network 100 executed by the GPU 10, while using the memory 70 as a work area.

The memory 70 functions as a memory device. The memory 70 stores input data input from outside the computer system 1, data generated by the GPU 10, data generated by the CPU 20, and parameters of neural networks. Note that the data generated by the GPU 10 and the CPU 20 may include intermediate results and final results of various calculations. For example, the memory 70 includes at least one selected from among DRAM, SRAM, MRAM, a NAND-type flash memory, a resistance-change-type memory (for example, ReRAM, Phase Change Memory (PCM)), etc. A dedicated memory (not illustrated) used by the GPU 10 may be directly connected to the GPU 10.

The input data may be provided from a storage medium 99. The storage medium 99 is electrically connected to the computer system 1 via a cable or wireless communication. The storage medium 99 functions as a memory device and may be any of a memory card, a USB memory, an SSD, an HDD, an optical storage medium, and the like.

FIG. 2 is a schematic diagram for explaining a configuration example of the neural network 100 executed by the computer system 1 of the embodiment.

In the computer system 1, the neural network 100 is used as a machine learning device. Herein, a machine learning is a technique to build an algorithm or a model, which carries out tasks such as categorization or prediction, by causing a computer to learn a massive amount of data. The neural network 100 is, for example, a convolutional neural network (CNN). The neural network 100 may be, for example, a multilayer perceptron (MLP) or a neural network provided with an attention mechanism (for example, Transformer).

The neural network 100 may be a machine learning device, which carries out inference of any data. For example, the neural network 100 may be a machine learning device which uses voice data as input and outputs categorization of the voice data, may be a machine learning device which realizes noise removal of voice data or voice recognition, or may be a machine learning device which realizes image recognition of image data. Note that the neural network 100 may be configured as a machine learning model.

The neural network 100 has an input layer 101, hidden layers (also referred to as intermediate layers) 102, and an output layer (also referred to as a fully connected layer) 103.

The input layer 101 receives input data (or part of the data) received from outside the computer system 1. The input layer 101 has a plurality of computing devices (also referred to as neurons or neuron circuits) 118. Note that the computing devices 118 may be dedicated devices or circuits, or the processing thereof may be realized by executing a program by a processor. Similar configurations will be described as computing devices also hereinafter. In the input layer 101, each computing device 118 subjects input data to arbitrary processing (for example, linear transformation, addition of auxiliary data, or the like) to carry out conversion and transmits the converted data to the hidden layers 102.

The hidden layers 102 (102A and 102B) execute various calculation processing with respect to the data from the input layer 101.

The hidden layers 102 have a plurality of computing devices 110 (110A and 110B). In the hidden layers 102, each computing device 110 executes product-sum operation processing using a particular parameter (for example, weight) with respect to supplied data (hereinafter, also referred to as device input data for distinguishing). For example, each of the computing devices 110 executes product-sum operation processing by using mutually different parameters with respect to the supplied data.

The hidden layers 102 may be layered. In this case, the hidden layer 102 includes at least two layers (the first hidden layer 102A and the second hidden layer 102B). The first hidden layer 102A has the plurality of computing devices 110A, and the second hidden layer 102B has the plurality of computing devices 110B.

Each computing device 110A of the first hidden layer 102A executes particular calculation processing with respect to device input data, which is the processing result of the input layer 101. Each computing device 110A transmits the calculation result to each of the computing devices 110B of the second hidden layer 102B. Each computing device 110B of the second hidden layer 102B executes particular calculation processing with respect to device input data, which is the calculation result of each computing device 110A. Each computing device 110B transmits the calculation result to the output layer 103.

In a case in which the hidden layer 102 has a layered structure in this manner, an ability of inference and learning (learning/training) by the neural network 100 can be improved. Note that the number of the layers of the hidden layers 102 may be three layers or more or may be one layer. One hidden layer may be configured to include an arbitrary combination of processing such as product-sum operation processing, pooling processing, normalization processing, and/or activation processing.

The output layer 103 receives the results of the various calculation processing executed by the computing devices 110 of the hidden layers 102 and executes various processing.

The output layer 103 has a plurality of computing devices 119. Each computing device 119 executes particular processing with respect to device input data, which is the calculation results of the plurality of computing devices 110B. As a result, based on the calculation results of the hidden layers 102, inference such as recognition and categorization about the input data supplied to the neural network 100 can be executed. Each computing device 119 can store and output obtained processing results (for example, categorization results). The output layer 103 also functions as a buffer and an interface for outputting the calculation results of the hidden layers 102 to outside the neural network 100.

Note that the neural network 100 may be provided outside the GPU 10. In other words, the neural network 100 may be realized by using not only the GPU 10, but also, for example, the CPU 20, the memory 70, and the storage medium 99 in the computer system 1.

The computer system 1 of the present embodiment executes, for example, various calculation processing for inference in voice recognition or image recognition and various calculation processing for machine learning (for example, deep learning) by the neural network 100.

For example, in the computer system 1, based on the various calculation processing by the neural network 100 with respect to image data, it is possible to carry out recognition and categorization with high accuracy to find out what the image data is or to carry out learning so as to recognize/categorize the image data with high accuracy.

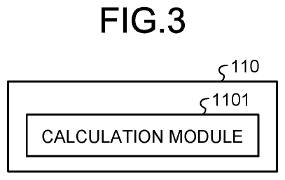

FIG. 3 is a functional block diagram illustrating a functional configuration of the computing device 110 of the embodiment. As illustrated in FIG. 3, the computing device 110 includes a calculation module 1101. The calculation module 1101 sums the products of the number of product-sum operations in the neural network 100 and the bit widths (bit width: the number of bits) of weight, with respect to a group which is set depending on specifications of hardware to which the neural network 100 is applied. Herein, quantization of a neural network is a method of expressing a parameter such as weight, which is normally expressed by a floating decimal point, by several bits (1 to 8 bits). Also, a group is a unit to which quantization is applied. By using these, the calculation module 1101 calculates inference time in the neural network including quantized groups. Details will be described below.

The inference time of a convolutional neural network (CNN) including quantized groups is determined by following three factors related to calculation cost. Herein, the calculation cost refers to processing time and power consumption of inference.

(1) The number of product-sum operations of a convolutional neural network (CNN)

(2) Bit width dependency of the calculation speed of hardware to which the neural network is applied

(3) Unit of groups processed by the same bit accuracy

Since a calculation strength of a convolutional neural network (CNN) is high, calculation time and the calculation speed of hardware rather becomes a bottleneck than memory access time or a band width. Therefore, in order to reduce the inference time, the calculation amount (for example, the number of product-sum operations) and the calculation speed of hardware should be taken into consideration instead of a model size or memory usage. Therefore, regarding the factor (1), the number of product-sum operations of the convolutional neural network (CNN) is dominant.

Regarding the factor (2), it is known that the reciprocals of the calculation speed, in other words, the calculation time and the bit width satisfy a proportional relation in hardware as described in below described literature.

“FPGA-based CNN Processor with Filter-Wise-Optimized Bit Precision”, A. Maki, D. Miyashita, K. Nakata, F. Tachibana, T. Suzuki, and J. Deguchi, in IEEE Asian Solid-State Circuits Conference 2018.

The factor (3) depends on the specifications of hardware. For example, depending on the hardware, calculations are carried out with the same bit accuracy in the unit of the kernel of GPU, or calculations are carried out with the same bit accuracy in the unit of a filter of the convolutional neural network (CNN).

For the above reasons, the inference time of the convolutional neural network (CNN), which includes quantized groups, can be estimated by summing the products of the number of product-sum operations and the bit widths of weight with respect to the processed group.

In the present embodiment, in dedicated hardware capable of carrying out computation with a plurality of mixed bit widths (for example, 1 to 8 bits), it is assumed that the inference time is determined by a calculation amount of Σ(Number of product-sum operations)×(Bit width of weight).

In such dedicated hardware capable of computing a plurality of mixed bit widths (for example, 1 to 8 bits) related to weight, there is a demand to reduce the above described calculation amount, which determines the inference time, while maintaining recognition accuracy.

Therefore, in the present embodiment, a regularization method using an index of calculation cost correlated to inference time is proposed. Specifically, estimated inference time is added to an error function, and weight and a quantization step size are optimized while taking both of inference time and recognition accuracy into consideration. As a result, allocation of the bit width that realizes high recognition accuracy with less inference time can be obtained. Details will be described below.

Hereinafter, a procedure of quantizing weight will be described. Also, an index (calculation amount) for calculating inference time is referred to as MAC×bit and defined as below.

MAC×bit=Σ(#MAC operations)_{g}×b_{g} (1)

Herein, an exponent g represents a group to which quantization is applied. By appropriately setting the exponent g in accordance with the specifications of the hardware to which the neural network is applied, the calculation amount in the hardware to which the neural network is applied can be expressed by the above described equation (1). Also, “b” represents a bit width required for expressing the quantized weight.

In the present embodiment, small bit widths are allocated to layers or filters, which do not contribute to recognition accuracy among the layers and filters constituting the neural network, so as to reduce the bit widths of the weight that does not affect the inference result in quantization and reduce the amount of calculations while maintaining recognition accuracy. Methods to find out optimum allocation of the bit widths include an optimization method based on a gradient descent method. The gradient descent method is an algorithm that updates the weight little by little and searches for a point at which the gradient becomes minimum. In the method based on the gradient descent method, as well as learning of weight, a parameter such as a quantization step size used in quantization is set as a variable, and the weight and the quantization step size are optimized so as to reduce errors in accordance with the gradient descent method. Then, based on the optimized values of the weight and the quantization step size, optimum allocation of bit widths can be obtained.

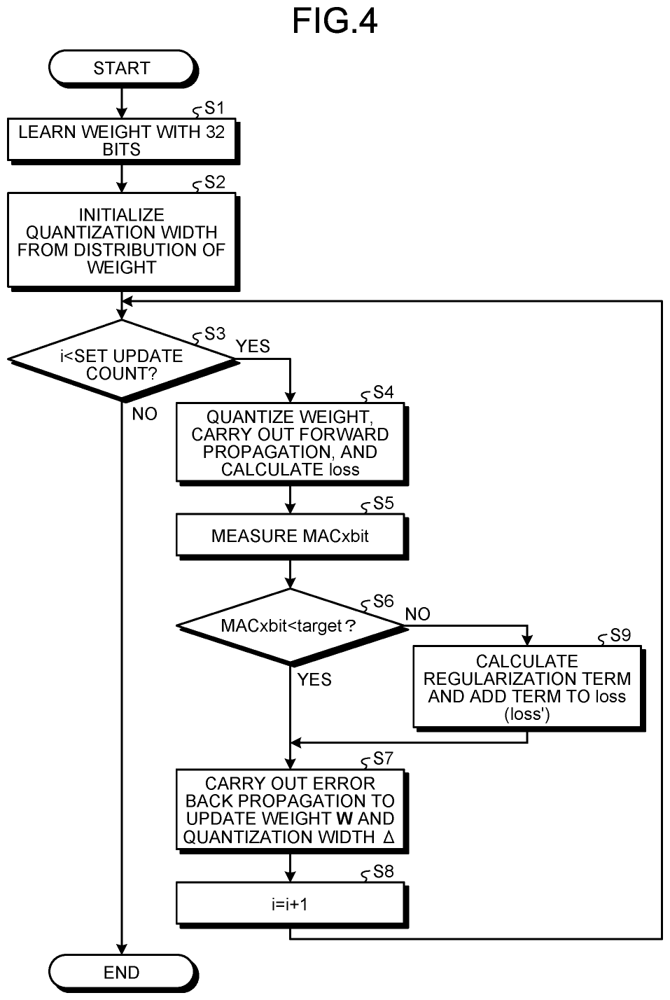

Herein, FIG. 4 is a flow chart illustrating a flow of an optimization process based on the gradient descent method of the embodiment. Note that, in the present embodiment, dedicated hardware which supports computing in which a plurality of bit widths (for example, 1 to 8 bits) are mixed is used. The bit width of weight is variably set to 1 to 8 bits in accordance with the specifications of the dedicated hardware, and activation is fixed to 8 bits.

As illustrated in FIG. 4, first, the calculation module 1101 sets a target data set and a network and learns a weight W with 32 bits (S1).

Then, the calculation module 1101 initializes a quantization step size from the distribution of the values of the weight after learning (S2). More specifically, for example, an initial bit width before optimization is set to 8 bits, and the quantization step size is initialized to a value obtained by dividing a difference between the maximum value and the minimum value of the weight by 2 to the power of 8.

Then, the calculation module 1101 determines whether the carried-out update count i has not exceeded an update count set in advance (S3).

If the carried-out update count i is not exceeding the update count (Yes in S3), the calculation module 1101 quantizes the weight by a current quantization step size and carries out learning again by forward propagation to calculate loss (S4).

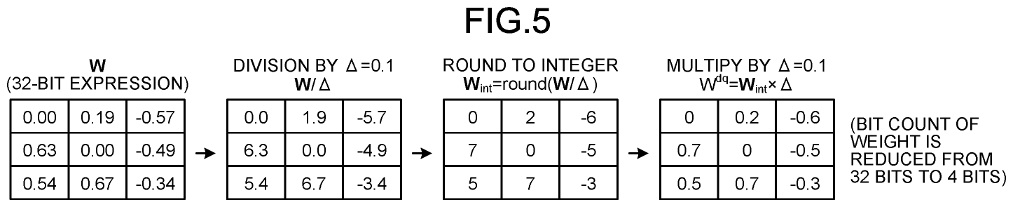

Herein, a procedure of weight quantization in the present embodiment will be described by referring to FIG. 5. FIG. 5 is a diagram illustrating an example of quantization. The example of quantization illustrated in FIG. 5 uses a quantization step size 4=0.1. According to the example of quantization illustrated in FIG. 5, the bit width of the weight W is reduced from 32 bits to 4 bits. In the present embodiment, it is assumed to carry out inference by using dedicated hardware capable of carrying out computing in which a plurality of bit widths (for example, 1 to 8 bits) are mixed. Normally, a weight of 32 bits is used in the calculation of forward propagation in learning. However, the bit width of weight is quantized to 1 to 8 bits in the stage of learning in accordance with the specifications of the dedicated hardware (supporting 1 to 8 bits) of the present embodiment.

When the weight W is quantized by the quantization step size Δ, the quantized weight Wᵢₙₜ is expressed by the following equation (2).

Wₙᵢₜ=round(W/Δ) (2)

Herein, “round” is a function that rounds the value of an input argument to a closest integer value. Also, in the calculation of forward propagation, W^{dq} reversed from the quantization of Wᵢₙₜ is expressed by the following equation (3).

W^{dq}=Wᵢₙₜ×Δ (3)

A bit width b_{g} required for expressing the quantized weight Wᵢₙₜ can be expressed by the following equation (4).

b_{g}=┌log₂(max_{g}(abs(Wᵢₙₜ^{g})+1┐ (4)

Herein, ┌⋅┐ represents ceiling function, max(⋅) represents max fun.

Herein, the exponent g represents the groups to which quantization is applied and is appropriately set in accordance with the specifications of hardware to which the neural network is applied. For example, in a case in which the hardware of the above described literature serves as a target to which the neural network is applied, the exponent g represents a filter(s).

In the method based on the gradient descent method, the weight W and the quantization step size Δ are set as parameters, and the weight W and the quantization step size Δ are repeatedly updated to carry out optimization so as to minimize errors in accordance with the gradient descent method. Then, the allocation of the bit width of the weight W optimized from the equation (4) is obtained.

Returning to FIG. 4, next, the calculation module 1101 measures MAC×bit, which is an index (calculation amount) for calculating inference time (S5). More specifically, the calculation module 1101 calculates MAC×bit of a final layer from MAC×bit of a first layer and obtains a sum thereof.

Subsequently, the calculation module 1101 determines whether MAC×bit measured in S5 is smaller than a threshold value (target) or not (S6). If measured MAC×bit is smaller than the threshold value (target) (Yes in S6), the calculation module 1101 updates the weight W and the quantization step size Δ by executing error back propagation by using loss calculated in S4 (S7) and increments the carried-out update count i by 1 (S8). Then, the process returns to (S3).

Herein, the processing of S7 will be described in detail. Normally, an error back propagation method is used in learning, information (δLoss/δW) for adjusting (optimizing) the weight W is calculated in order to reduce Loss, and the following equation (5) is calculated by using the information (δLoss/δW), and, as a result, the weight W can be adjusted so as to reduce errors.

$$W = W - η \frac{\partial Loss}{\partial W} \qquad ( 5 )$$

Note that a calculation procedure of the information (δLoss/δW) is as described below.

$$\frac{\partial Loss}{\partial W} = \frac{\partial Loss}{\partial {W}^{dq}} ( \frac{\partial Loss}{\partial {W}^{dq}} is calculated in accordance with normal error back propagation ) \qquad ( 6 )$$

Similarly, also regarding the quantization step size Δ, the quantization step size Δ can be adjusted so as to reduce errors by obtaining (δLoss/δΔ) by the error back propagation method by the following equation (7) and then calculating the following equation (8).

$$\begin{matrix}\frac{\partial Loss}{\partial Δ} = \frac{\partial Loss}{\partial {W}^{dq}} \cdot \frac{\partial {W}^{dq}}{\partial Δ} \\ \frac{\partial {W}^{dq}}{\partial Δ} = - W \text{/} Δ + round ( W \text{/} Δ ) & ( 7 ) \\ Δ = Δ - η \frac{\partial Loss}{\partial Δ} & ( 8 )\end{matrix}$$

On the other hand, if measured MAC×bit is larger than the threshold value (target) (No in S6), the calculation module 1101 calculates a regularization term and adds the term to loss to obtain loss' (S9). Then, the calculation module 1101 executes error back propagation by using loss' calculated in S9, thereby updating the weight W and the quantization step size Δ (S7).

A regularization term of a comparative example has been learned to add a model size (obtained by multiplying the element count of weight by a bit width) as a penalty to errors so as to reduce errors in a manner of the below-described equation (9). However, it has not been an optimum solution although the calculation amount (MAC×bit) is reduced if the model size is reduced.

$${Loss}^{′} = Loss ( x , W , t ) + λ ( Modelsize ( W , Δ ) ) \\ \begin{matrix}Modelsize ( W , Δ ) = {Σ}_{l} ( Element count of {W}_{l} ) \times {bit}_{l} ( {W}_{l} , {Δ}_{l} ) \\ = {Σ}_{j} {C}_{o , l} {C}_{i , l} {K}_{h , l} {K}_{w , l} \times {bit}_{l} ( {W}_{l} , {Δ}_{l} )\end{matrix} \qquad ( 9 )$$

On the other hand, as described in the below-described equation (10), the regularization term of the present embodiment takes the size (O_{h,l}, O_{w,l}) of an output image into consideration and is configured to add the calculation amount (MAC×bit) as a penalty.

$${Loss}^{′} = Loss ( x , W , t ) + λ ( MACxbit ( W , Δ ) ) \\ \begin{matrix}MACxbit ( W , Δ ) = & {Σ}_{l} ( Number of product - sum \\ & operations carried out with {W}_{l} ) \times \\ & {bit}_{l} ( {W}_{l} , {Δ}_{l} ) \\ = & {Σ}_{l} {O}_{h , l} {O}_{w , l} {C}_{o , l} {C}_{i , l} {K}_{h , l} {K}_{w , l} \times {bit}_{l} ( {W}_{l} , {Δ}_{l} )\end{matrix} \qquad ( 10 )$$

The calculation module 1101 repeats the processing of S4 to S9 until the number of carried-out update count i exceeds the update count set in advance (No in S3). If the carried-out update count i has exceeded the update count set in advance (No in S3), the calculation module 1101 terminates the processing.

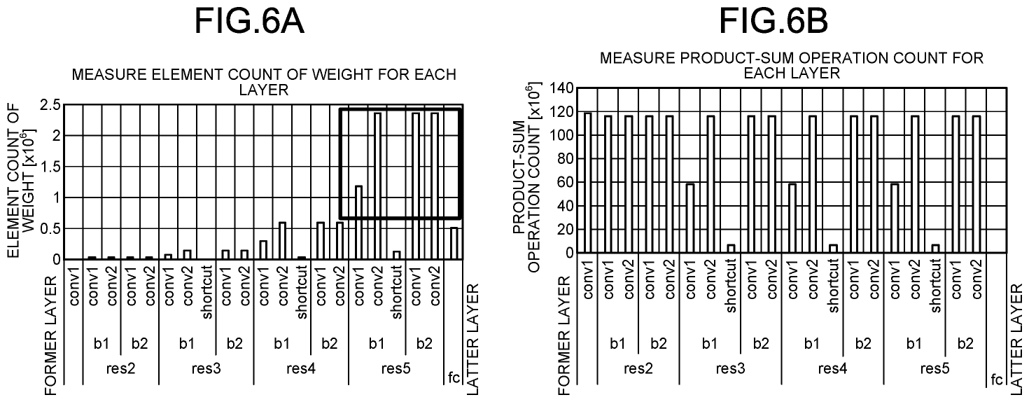

Herein, differences in the points focused in the methods of the embodiment and the comparative example will be described. FIG. 6A is a diagram illustrating a measurement example by a method of a comparative example; FIG. 6B is a diagram illustrating a measurement example by a method of the embodiment; In FIG. 6A, as the method of the comparative example, the element count of the weight of a neural network called ResNet-18 is measured for each layer. In FIG. 6B, as the method of the embodiment, the number of product-sum operations is measured for each layer. The result of multiplying the element count of weight by the bit width is represented by Model size, and the result of multiplying the number of product-sum operations by the bit width represents the calculation amount (MAC×bit) described in the present embodiment.

As illustrated in FIG. 6A, if the element count of weight is measured for each layer, the more the layer gets close to the end, the higher the element count. Therefore, in the method of the comparative example, the weight W and the quantization step size Δ are adjusted so as to reduce the bit width of the latter layers in order to reduce Model size. As a result, in this network called ResNet-18, the calculation amount (MAC×bit) in the latter layers also becomes small. On the other hand, if the product-sum operation count is measured for each layer as illustrated in FIG. 6B, it can be understood that differences in the product-sum operation count among former layers and latter layers are small (uniform). Therefore, in the method of the embodiment, the weight W and the quantization step size Δ are adjusted so that the bit widths of the former layers and the latter layers are uniformly reduced in order to reduce the calculation amount (MAC×bit). Also, in the network called ResNet-18, the calculation amount (MAC×bit) also becomes uniform as a result.

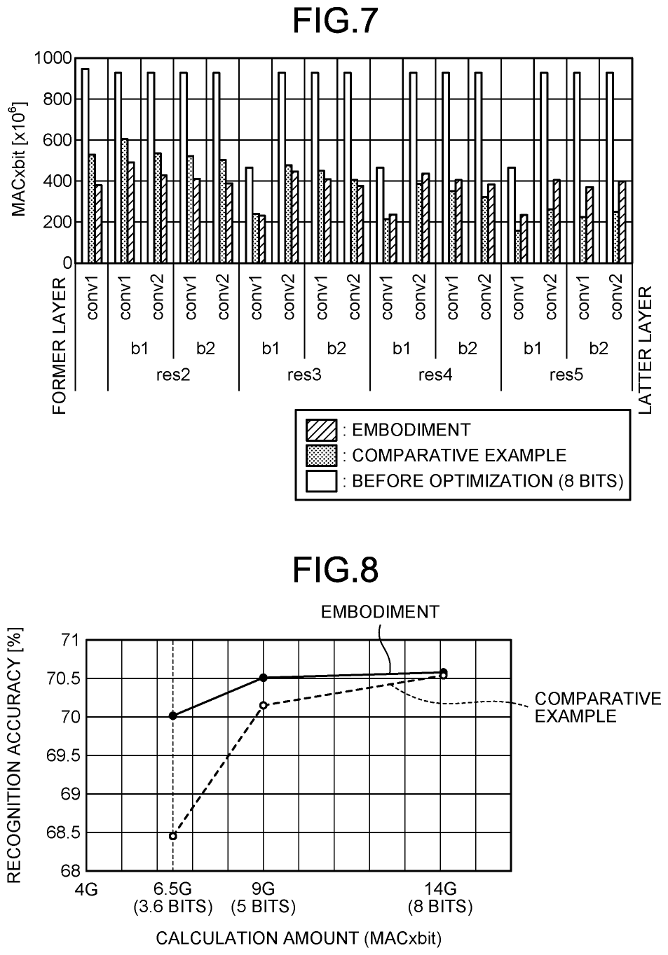

Herein, FIG. 7 is a diagram illustrating effects of the methods of the embodiment and the comparative example. In the example illustrated in FIG. 7, the value of the calculation amount (MAC×bit) is measured for each layer after the weight W and the quantization step size Δ are adjusted. As illustrated in FIG. 7, it can be understood that differences in the calculation amount (MAC×bit) are small (uniform) among the former layers and the latter layers in the result after optimization. On the other hand, in the method of the comparative example, the calculation amount (MAC×bit) is large in the former layers, and the calculation amount (MAC×bit) is small in the latter layers.

Herein, FIG. 8 is a diagram illustrating an example of a relation between the calculation amount (MAC×bit) and the recognition accuracy in the methods of the embodiment and the comparative example. As illustrated in FIG. 8, it can be understood that the recognition accuracy is higher in the method of the present embodiment than the method of the comparative example with respect to equivalent calculation amounts. In the example illustrated in FIG. 8, it is notable particularly in the vicinity of the total calculation amount (MAC×bit) of 6.5×10⁹ (corresponding to average of 3.6 bits).

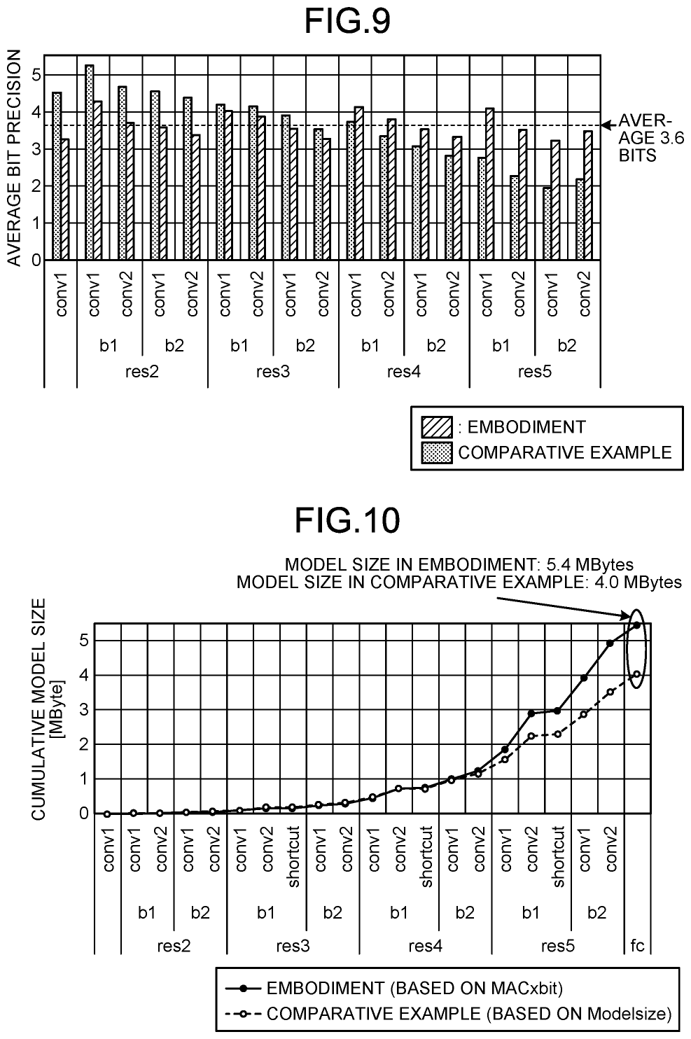

Herein, FIG. 9 is a diagram illustrating an example of differences in effects of bit widths in the methods of the embodiment and the comparative example. In the example illustrated in FIG. 9, an average bit width is measured for each layer after the weight W and the quantization step size Δ are adjusted so that the total of the calculation amount (MAC×bit) becomes 6.5×10⁹ (corresponding to average 3.6 bits). As illustrated in FIG. 9, it can be understood that bit widths (3 to 4 bits) are around 3.6 bits overall in the method of the present embodiment. On the other hand, it can be understood that bit widths in former layers are large (4 to 5 bits) and those of latter layers are small (2 to 3 bits) in the method of the comparative example.

FIG. 10 is a diagram exemplarily illustrating a cumulative model size after the weight W and the quantization step size Δ are adjusted in the methods of the embodiment and the comparative example. The example illustrated in FIG. 10 illustrates the cumulative model size obtained by sequentially adding (cumulative sum) model sizes from a first layer after the weight W and the quantization step size Δ are adjusted so that the total of the calculation amount (MAC×bit) becomes 6.5×10⁹ (corresponding to average 3.6 bits). According to the method of the present embodiment, the more the layer gets close to the end, the larger the contribution (increase) to the model size. On the other hand, according to the method of the comparative example, the latter layers have 1 bit smaller than those of the method of the present embodiment as shown in the result of the method of the comparative example illustrated in FIG. 9. Therefore, it can be understood that the total of the model size also becomes small, which leads to deterioration of recognition accuracy.

In this manner, according to the present embodiment, the result of summing the products of the number of product-sum operations and the bit widths of the weight for the product-sum operations in the neural network with respect to the group to which quantization is applied is used to calculate the calculation amount in the inference time of the neural network. Then, based on the calculated calculation amount, the value of the weight and the quantization step size are configured to be optimized to minimize recognition errors by the neural network. As a result, effects that high recognition accuracy can be realized with less inference time in consideration of the calculation amount and the calculation performance of hardware can be obtained.

Note that the computing device of the present embodiment, the computer system including the computing device of the present embodiment, and the storage medium that stores the computing method of the present embodiment can be applied to smartphones, mobile phones, personal computers, digital cameras, car-mounted cameras, monitor cameras, security systems, AI equipment, system libraries (databases), artificial satellites, and so on.

The above described description shows an example in which the computing device, the computer system, and the computing method of the present embodiment are applied to the neural network in the computer system 1 related to natural language processing of processing a human language (natural language) by a machine. However, the computing device and the computing method of the present embodiment can be applied to various computer systems including neural networks and various data processing methods of executing calculation processing by neural networks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing device comprising:
a processor configured to:
calculate a calculation amount in inference time of a neural network, using a result of summing, with respect to a group to which quantization is applied, products of the number of product-sum operations and bit widths of weight for the product-sum operations in the neural network;
optimize a value of the weight and a quantization step size to minimize a recognition error by the neural network based on the calculated calculation amount; and
execute computing about the neural network based on the optimized weight and the quantization step size.

2. The computing device according to claim 1, wherein
the processor is configured to set the weight and the quantization step size as parameters and repeatedly update the weight and the quantization step size to minimize the recognition error for optimization of the weight and the quantization step size in accordance with a gradient descent method of searching for a point of a minimum gradient by updating the weight.

3. The computing device according to claim 1, wherein
the processor is configured to:
allocate, among layers or filters constituting the neural network, a smaller bit width to a layer or a filter not contributing to recognition accuracy than that of a layer or a filter contributing to the recognition accuracy; and
reduce a bit width of weight not affecting an inference result to calculate the calculation amount in the inference time of the neural network.

4. The computing device according to claim 1, wherein
the processor is configured to calculate the calculation amount in the inference time of the neural network by using a regularization method using an index of calculation cost correlated to the inference time.

5. A computer system comprising:
a computing device comprising a processor; and
a memory device configured to store data computed by the computing device, wherein the processor is configured to:
calculate a calculation amount in inference time of a neural network, using a result of summing, with respect to a group to which quantization is applied, products of the number of product-sum operations and bit widths of weight for the product-sum operations in the neural network;
optimize a value of the weight and a quantization step size to minimize a recognition error by the neural network based on the calculated calculation amount; and
execute computing about the neural network based on the optimized weight and the quantization step size.

6. The computer system according to claim 5, wherein
the processor is configured to set the weight and the quantization step size as parameters and repeatedly update the weight and the quantization step size to minimize the recognition error for optimization of the weight and the quantization step size in accordance with a gradient descent method of searching for a point of a minimum gradient by updating the weight.

7. The computer system according to claim 5, wherein
the processor is configured to:
allocate, among layers or filters constituting the neural network, a smaller bit width to a layer or a filter not contributing to recognition accuracy than that of a layer or a filter contributing to the recognition accuracy; and
reduce a bit width of weight not affecting an inference result to calculate the calculation amount in the inference time of the neural network.

8. The computer system according to claim 5, wherein
the processor is configured to calculate the calculation amount in the inference time of the neural network by using a regularization method using an index of calculation cost correlated to the inference time.

9. A computing method comprising:
calculating a calculation amount in inference time of a neural network, using a result of summing, with respect to a group to which quantization is applied, products of the number of product-sum operations and bit widths of weight for the product-sum operations in the neural network;
optimizing a value of the weight and a quantization step size to minimize a recognition error by the neural network based on the calculated calculation amount; and
executing computing about the neural network based on the optimized weight and the quantization step size.

10. The computing method according to claim 9, further comprising:
setting the weight and the quantization step size as parameters and repeatedly updating the weight and the quantization step size to minimize the recognition error for optimization of the weight and the quantization step size in accordance with a gradient descent method of searching for a point of a minimum gradient by updating the weight.

11. The computing method according to claim 9, further comprising: allocating, among layers or filters constituting the neural network, a smaller bit width to a layer or a filter not contributing to recognition accuracy than that of a layer or a filter contributing to the recognition accuracy; and
reducing a bit width of weight not affecting an inference result to calculate the calculation amount in the inference time of the neural network.

12. The computing method according to claim 9, further comprising:
calculating the calculation amount in the inference time of the neural network by using a regularization method using an index of calculation cost correlated to the inference time.
